(19) United States
(12) Patent Application Publication
(10) Pub. No.: US 2023/0034378 A1
(43) Pub. Date: Feb. 2, 2023

(54) METHOD FOR DETERMINING THE REQUIRED OR IDEAL LENGTH OF A CABLE IN A HEARING AID

(71) Applicants: Sivantos Pte. Ltd., Singapore (SG); Widex A/S, Lynge (DK)

(72) Inventors: Frank Naumann, Bubenreuth (DE); Morten Kroman, Taastrup (DK)

(21) Appl. No.: 17/876,859

(22) Filed: Jul. 29, 2022

(30) Foreign Application Priority Data
Jul. 29, 2021 (DE) 10 2021 208 260.2

(51) Int. Cl. H04R 25/00; H04R 1/10

(52) U.S. Cl. CPC H04R 25/70; H04R 1/1033; H04R 2225/0216; H04R 2225/55

(57) ABSTRACT

The use of the correct, required length of a cable in a hearing aid substantially contributes to the wearing comfort of the hearing aid. At least one ear depiction of an ear is created by a camera. An associated ear geometry is determined on the basis of the ear depiction. The required length of the cable for the hearing aid can in turn be determined by use of the ear geometry.

### CROSS-REFERENCE TO RELATED APPLICATION

This application claims the priority, under 35 U.S.C. § 119, of German Patent Application DE 10 2021 208 260.2, filed Jul. 29, 2021; the prior application is herewith incorporated by reference in its entirety.

### FIELD AND BACKGROUND OF THE INVENTION

The invention relates to a method for determining the required or ideal length of a cable in a hearing aid.

A hearing aid is used to care for a hearing-impaired person using acoustic surroundings signals, which are processed appropriately for compensation of the respective hearing impairment and in particular are amplified. The output takes place here by means of an output transducer, usually acoustically via airborne sound by means of a loudspeaker (also referred to as a receiver). For this purpose, the hearing aids normally comprise an acoustic input transducer (in particular a microphone) and a signal processor, which is configured to process an input signal generated by the input transducer from the acquired ambient noises while using at least one signal processing algorithm in such a way that a hearing loss of the wearer of the hearing aid is at least partially compensated. In particular in the case of a hearing aid device, the output transducer, in addition to a loudspeaker, can alternatively also be a so-called bone vibrator or a cochlear implant, which are configured for the mechanical or electrical coupling of the sound signal into the sense of hearing of the wearer.

To satisfy the numerous individual requirements, different structural forms of hearing aids are offered. In the so-called BTE hearing aids (behind-the-ear), a housing having components such as a battery and the signal processing unit is worn behind the ear. Depending on the design, the receiver can be inserted directly into the auditory canal of the wearer (so-called ex-receiver hearing aids or receiver in the canal or RIC hearing aids). Alternatively, the receiver is arranged inside the housing itself and a flexible sound tube, also referred to as a tube, conducts the acoustic output signals of the receiver from the housing to the auditory canal (tube hearing aids). It is also possible to use a cable having an additional cavity along the course of the cable.

BTE or RIC hearing aids use a cable which connects the hearing aid to an earpiece. The earpiece typically has an external contour which is used for the seal against the auditory canal. The earpiece is often formed as a so-called dome (also called a shield) in particular in BTE hearing aids. The dome is fastened on a fitting part, which is in turn connected to the receiver. In an RIC hearing aid, the fitting part is, for example, a fitting connecting piece of the receiver. In the case of a receiver worn outside the auditory canal, the fitting part is, for example, a sound tube, which is possibly equipped with a suitable connecting part, for connection to the dome.

In principle, all connection solutions which are suitable for connecting the earpiece to the receiver in an RIC hearing aid are also suitable for the connection of an earpiece to a sound tube in a BTE hearing aid having receiver behind the ear. The term cable is to be used synonymously hereinafter for the different connection solutions.

A hearing aid usually has to be individually fitted for its user. This includes the fitting to the most ideal possible seat on the ear of the user. In BTE or RIC hearing aids, the cable between hearing aid and the receiver or the dome in the auditory canal moreover has to be fitted. That is to say, a required or ideal length has to be found for the cable starting from the ear geometry of the user. This has been effectuated up to this point by testing out various prefinished cable lengths multiple times. This represents a time-consuming and costly step in the fitting of a hearing aid.

### SUMMARY OF THE INVENTION

It is the object of the present invention to solve this problem.

This problem is solved according to the invention by a method for determining the required or ideal length of a cable in a hearing aid, which is worn on an ear, wherein at least one ear depiction is created by means of a camera, and wherein the ear geometry is determined on the basis of the at least one ear depiction. The required or ideal length of the cable is subsequently determined on the basis of the determined ear geometry. The use of the correct, thus the required or ideal length of a cable in a hearing aid significantly contributes to the wearing comfort of the hearing aid.

A required or ideal length of the cable is the length which, as described above, connects the hearing aid to external components, for example, an in-ear receiver or an earmold, without pressing too closely against regions of the ear and also without being too wide to form possible wide bends or loops in which objects could catch. A cable which is too short can result in pain in the wearer or even cut into the ear. The required length of the cable is typically the length of the cable which is responsible for the correct seat of the hearing aid behind the ear. Moreover, there are various functions in hearing aids such as directional hearing, which under certain circumstances do not operate perfectly if the cable length is not fitted appropriately.

This cable length is not necessarily a fixed dimension in the form of a specific length specification. The required or ideal cable length can also be a relative length range or indexed lengths. For example, predefined lengths are numbered or identified by the references such as 0 to 5. The cable having the length 3 can be selected therefrom, for example. However, simple length ranges are also possible, for example, from 2.5 cm to 3 cm.

The term cable represents one of multiple connection solutions here. Depending on the intended use, the cable is hollow, partially hollow, an acoustic line, or it contains an electric line.

The ear geometry in this meaning is the three-dimensional shape of the ear. This includes, inter alia, the ear size, the ear shape, and different dimensions or variables of the components of the ear.

Methods for determining the ear geometry are, for example, biometric methods. Reference points are placed on various parts of the ear, for example, the tragus or the antitragus, etc., by means of computer-assisted aids. These are then related to one another to determine the ear geometry therefrom.

Preferably, the ear geometry and the geometry of the hearing aid are compared so that the required length of the cable is determined therefrom. For example, an algorithm compares the ear geometry and the geometry of the hearing aid. Various form factors, dimensions, shapes, etc., thus their geometries or geometric shapes, are known of the various hearing aid types and variants. Moreover, in this case the determined ear geometry is also known, thus the shape, size, proportions, dimensions, etc. of the ear and its components, for example, tragus, antitragus, etc., both as a whole and also in relation to one another. The comparison can be carried out, for example, by a computer-assisted method by means of a corresponding algorithm. In principle, however, a required length of the cable can already be determined solely on the basis of the ear geometry.

The hearing aid is preferably a hearing aid wearable behind the ear. A cable leads from the hearing aid to an auditory canal of the ear or vice versa. In this case, the hearing aid is worn at the transition between ear and head, on the upper region of the ear, behind the helix. A further component, for example, a dome or an earmold having an in-ear receiver, is inserted into the auditory canal. The hearing aid has to be connected to this component by means of a cable. The cable is to have an ideal distance between the hearing aid and the component in the auditory canals so as not to irritate the user.

Preferably, the camera creates one or more ear depictions and determines a three-dimensional ear geometry therefrom. A greater number of ear depictions from various angles and perspectives increases the accuracy of the ear geometry determined therefrom. However, one ear depiction is also sufficient to determine a sufficiently precise ear geometry.

A reference object having previously known geometrical dimensions is preferably also depicted on the at least one ear depiction, so that the ear geometry is determined or co-determined on the basis of the reference object. The determination of the ear geometry can be related solely to the reference object in this case. However, the ear geometry can also be determined or co-determined by means of a combination with the reference to the reference object and another method. Reference objects can be, for example, coins, rulers, or the like.

The at least one ear depiction is preferably compared to previously stored, other ear depictions, in which the ear geometry is known, so that the ear geometry is thus determined or co-determined. A digitally stored ear depiction is compared for this purpose to other digitally stored reference objects. The geometrical dimensions of the reference objects are known beforehand so that the ear geometry can be calculated or determined therefrom with reference thereto.

In a further embodiment, specific regions or previously marked reference points or patterns on the ear depiction are compared. For example, reference points can be marked along the silhouette of the tragus or the antitragus. These form a specific pattern which is compared to other patterns of the respective region of the ear depiction. These patterns can also be related to one another and compared in order to determine ear geometry and the required length of a cable.

The at least one ear depiction and/or the determined ear geometry is preferably displayed on a display device, and various sizes or lengths of cables are placed as an optical image or as a three-dimensional graphic on the representation of the at least one ear depiction. The respective geometries or dimensions of the ear geometry and the cable correspond here to their real relations to one another. The size relationships of ear geometry and various cables or cable lengths can thus be compared. For example, six prefinished cable lengths having the indexed length specifications 0 to 5, which covers the typically required spectrum of cable lengths. In a simplified form as a further exemplary embodiment, only one probably required length, for example length 2, can also be shown or mentioned here. In this case, the ear depiction and/or the ear geometry does not necessarily have to be displayed on a display device. An algorithm can execute the comparison of ear geometry and required cable length in the background here and determine the required cable length. As a result, for example, only “length 2” is then displayed as the required cable length.

Preferably, a required cable length determined with respect to the ear geometry is output as a length specification on a display device. For example, the required cable length can be automatically calculated and output by means of one of the mentioned procedures. The required cable length can also be a relative length range or indexed lengths. For example, predefined lengths having the references numbered or identified as 0 to 5. However, simple length ranges are also possible, for example, from 3 cm to 3.5 cm.

The cable can have an electrical conductor. For example, a wire extends inside the cable. A receiver, thus a hearing aid loudspeaker, can be arranged at one end of the cable. The cable can also be formed as a tube and can have a cavity.

Other features which are considered as characteristic for the invention are set forth in the appended claims.

Although the invention is illustrated and described herein as embodied in a method for determining the required or ideal length of a cable in a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing an embodiment of a sequence of a method according to the invention;

FIG. 2 is an illustration showing a further embodiment of the sequence of the method according to the invention;

FIGS. 3, 4, and 5 are illustrations showing various options to determine ear geometries; and

FIG. 6 is an illustration showing an exemplary camera having a lens system.

### DETAILED DESCRIPTION OF THE INVENTION

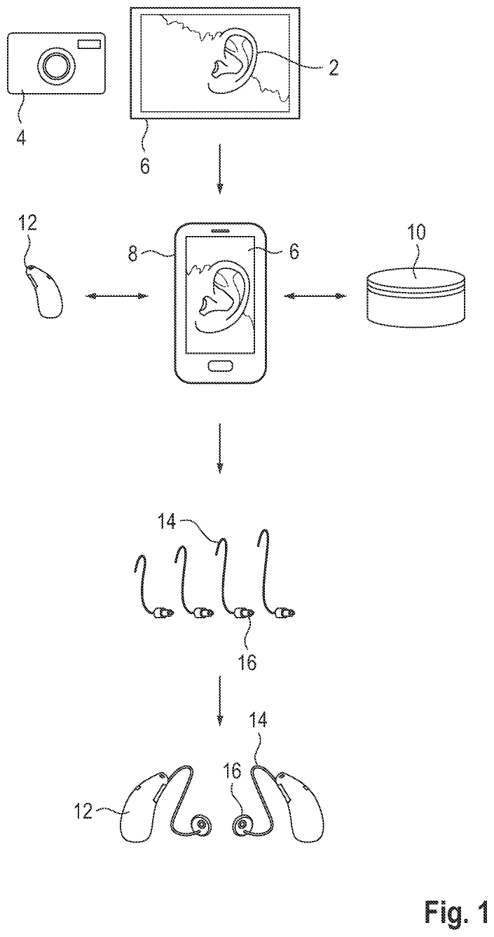

Referring now to the figures of the drawings in detail and first, particularly to FIG. 1 thereof, there is shown schematically the possible sequence of an embodiment of the method according to the invention. First, at least one ear depiction 6 of an ear 2 is created. This is carried out by means of a camera 4. The camera 4 can in this case be a conventional photo camera, a video camera, a film camera, or another device for recording and storing images. The ear depiction 6 is stored, for example, on a computer, smart phone 8, or similar digital device which permits the storage, display, and processing of images.

The geometry of the ear 2 is determined on the basis of the one or more ear depictions 6. This is carried out, for example, by means of various ear depictions 6 from different perspectives. It is also possible to determine the ear geometry from only one ear depiction 6. The ear depictions 6 can be compared to ear depictions stored previously in a database 10 to obtain the most accurate possible image of the ear geometry.

The ear geometry is the most detailed possible description of the ear 2. It can be two-dimensional or three-dimensional. Various noteworthy points and/or shapes of the ear 2 are considered to obtain the most accurate possible depiction of the ear 2 in the form of an ear geometry for the subsequent determination of the cable length.

In other words, on the basis of the ear depiction(s) 6, as much data as possible on the ear shape, ear size, dimensioning of the ear in relation to the head or other reference points are collected and evaluated. Specific reference points on the ear can also be abstracted, which are placed along components of the ear 2, for example, along the tragus, antitragus, etc. These can be related to one another to subsequently abstract the ear geometry therefrom. This will be explained on the basis of an example in FIG. 5.

Subsequently, a required length of a cable 14 can be determined on the basis of the ear geometry, which is to lead from a hearing aid 12 into the auditory canal of the ear 2. In another embodiment, the ear geometry can be compared to the previously known geometrical data of a selected hearing aid 12 and the length of a cable 14 can be determined therefrom. A so-called receiver 16, a hearing aid loudspeaker, is typically located on the ear-side end of the cable 14. The cable 14 connects hearing aid 12 and receiver 16. Because the geometries of ear 2 and hearing aid 12 are known, the ideal or required length of the cable 14 is hereby determined. Without such a procedure, the cables are often too short or too long and annoying to the user of the hearing aid 12.

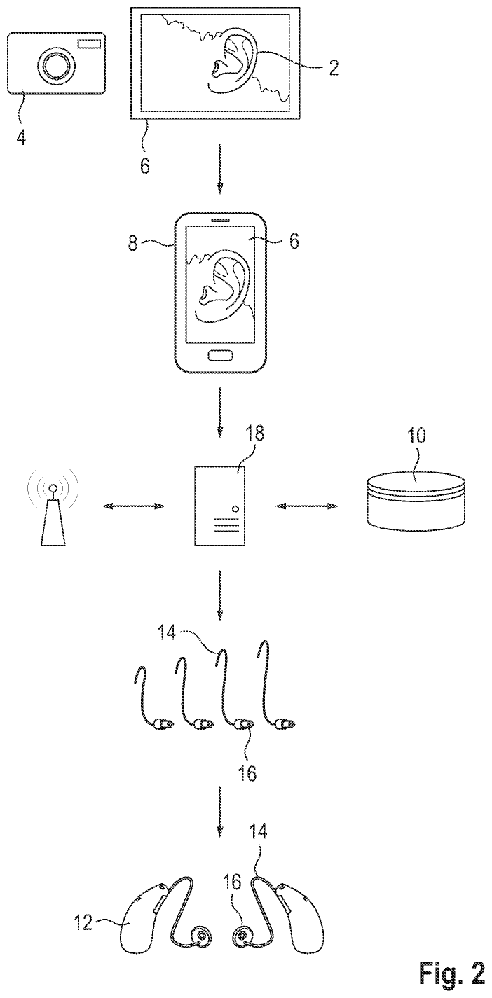

FIG. 2 shows a further embodiment of the method, wherein the determination of the ear geometry is carried out on a computer or remote server 18. For example, a person photographs their ear 2 at least once by means of the camera of a smart phone. These photos represent ear depictions 6, which are sent wirelessly to a remote server 18. This server then automatically carries out the determination of the ear geometry and the subsequent determination of the required cable length as described. Additionally, or alternatively, the ear geometry can be compared to the geometry of a hearing aid 12 to achieve a higher accuracy. In other words, an ear 2 and a hearing aid 12 are thus compared in the corresponding size relationship without a hearing aid acoustician (healthcare professional) being required.

In another embodiment, an algorithm is used to determine the ideal cable length based on the method according to the invention. An algorithm determines on the basis of the ear geometry which is the ideal cable length in the respective case. The correspondingly established cable length can subsequently be displayed or indicated on a display device such as a computer. In a further embodiment, an algorithm accesses the database 10, in which prior comparisons between ear depictions and ear geometries determined therefrom having the respective matching cable lengths are stored. The algorithm compares the ear depiction 6 and/or the ear geometry here to the prior ones which are stored in the database 10. This improves the quality of the result. Additionally, or alternatively, the algorithm can compare the ear geometry to the geometry of a hearing aid 12 to achieve a higher accuracy.

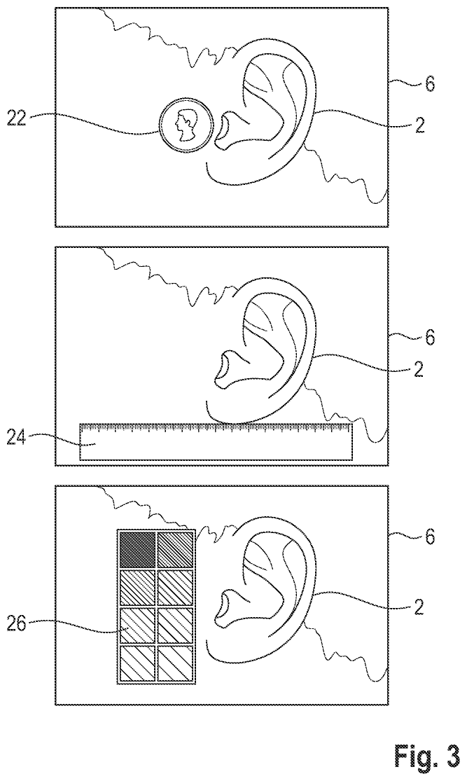

FIG. 3 shows multiple ear depictions 6. Various reference objects are also located on the ear depictions 6 here. The reference objects can be real or virtual objects. A reference object is, for example, a coin 22 or a ruler 24. It can also be a specific graphic object 26. In this example, the graphic object 26 has square fields having different color tones.

FIG. 4 shows a further embodiment for determining the ear geometry. A virtually drawn line having starting point and end point, shown as an arrow 28 or similar illustration, of which the length or the dimensions are known, can be used as a reference object.

In a further embodiment, the ear depictions 6 are provided digitally and are processed on a computer or similar device. The reference objects are also provided as a digital depiction having real size scale in a database 10, to which the computer has access. An arbitrary reference object such as a ruler 24 can thus be placed on the ear depiction 6. The scale of the ruler 24 corresponds to the scale of the ear depiction 6. The size of the ear 2 can thus be concluded starting from the reference object. In other words, the ear geometry can thus be determined with additional aid of a reference object.

In a further embodiment, a reference object is placed in the vicinity of the ear 2 during the creation of the ear depiction 6 by means of a camera 4, so that it can also be seen on the ear depiction 6. The dimensions of the ear 2 can thus be concluded from the known dimensions of the reference object and thus its ear geometry can be determined.

In a further embodiment, based on the method according to the invention, the ear depiction 6 is compared to previously stored other ear depictions in which the ear geometry is known. These previously stored ear depictions are retrievable, for example, from a database 10. Starting from the previously known ear depictions, a comparison can be executed automatically by means of an algorithm, which subsequently selects the appropriate corresponding ear geometry.

FIG. 5 shows two different ear depictions 6, wherein a reference point system 30 is arranged on each of the ears 2. In the reference point systems 30, individual reference points 32 are linked to one another. The distances of the reference points 32 in the reference point systems 30 are known or can be approximately determined. In this embodiment of the method according to the invention, the reference points 32 have been placed at various relevant positions on the ears 2, for example, the tragus, the antitragus, etc. The pattern of the reference points 32 thus resulting, thus the reference point systems 30, is correlated with the ideal cable length. The ideal cable length can thus be determined on the basis of this relation of the reference points 32 in the reference point systems 30.

Depending on the positioning of the reference points 32 in this embodiment of the method according to the invention, the ear geometry can moreover be determined three-dimensionally. In accordance with the need for accuracy, this can be carried out approximately by means of estimated distances or only distances, which are measured on the basis of the ear depiction 6, of the positions of the reference points 32 in relation to one another.

This method can be implemented as an automated, teachable method, so-called machine learning. By frequently carrying out and storing the method, a teachable algorithm can recognize the most accurate possible placement of the reference points 32 on the ear depictions 6 therefrom and carry it out itself. The method can thus be carried out without additional human steps for the placement of the reference points 32 and the creation of the reference point system 30.

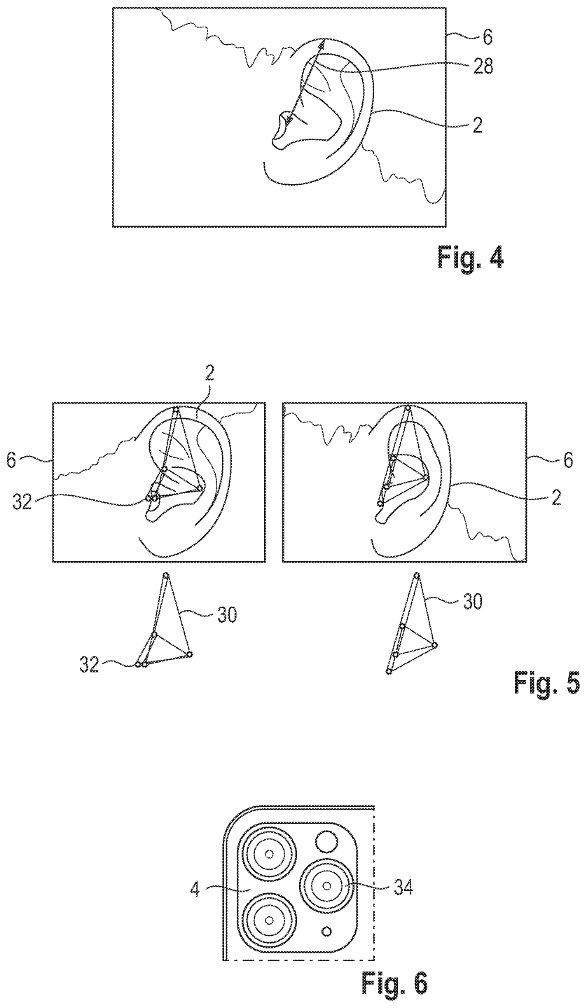

FIG. 6 shows by way of example a camera 4 having a lens system 34 made up of multiple lenses. The lenses are spaced apart from one another. Such a camera can make multiple ear depictions 6 of an ear 2 at the same time.

Each of the ear depictions 6 is thus displayed from an at least slightly offset angle. A three-dimensional ear geometry can be derived therefrom.

Depending on the camera 4 used, its respective components, for example, the lens shapes, sensor sizes, etc. are known. Additional conclusions about the distance or size of the photographed object, in this case the ear 2, can be calculated by means of different variables such as depth of field, focal length, etc. and the technical data of the components. This contributes to determining the ear geometry.

For all exemplary embodiments, the ear geometry can be at least approximately estimated depending on the quality, for example, of the ear depiction 6. An absolutely accurate determination of the ear geometry is not always necessary. It is sufficient if the required or ideal cable length of a cable 14 for a selected hearing aid 12 can be determined from the determined values. The required or ideal cable length is not necessarily a fixed variable in the form of a specific length specification. The required or ideal cable length can also be a relative length range or indexed lengths. For example, predefined lengths numbered or identified by the references such as 0 to 5. However, simple length ranges are also possible, for example, from 3.5 cm to 4 cm.

The following is a summary list of reference numerals and the corresponding structure used in the above description of the invention:
2 ear
4 camera
6 ear depiction
8 smart phone
10 database
12 hearing aid
14 cable
16 receiver
18 remote server
22 coin
24 ruler
26 graphic object
28 arrow vector
30 reference point system
32 reference point
34 lens system

1. A method for determining a required length of a cable in a hearing aid being worn on an ear, which comprises the steps of:
creating at least one ear depiction by means of a camera;
determining an ear geometry on a basis of the at least one ear depiction; and
determining the required length of the cable on a basis of the ear geometry.

2. The method according to claim 1, which further comprises comparing the ear geometry and a geometry of the hearing aid, so that the required length of the cable is determined therefrom.

3. The method according to claim 2, which further comprises providing an algorithm that compares the ear geometry and the geometry of the hearing aid.

4. The method according to claim 1, wherein the hearing aid is a hearing aid wearable behind the ear.

5. The method according to claim 1, wherein the cable leads from the hearing aid to an auditory canal of the ear or vice versa.

6. The method according to claim 1, wherein the camera creates the at least one ear depiction and a three-dimensional ear geometry is determined therefrom.

7. The method according to claim 1, which further comprises comparing a reference object having previously known geometric dimensions to the at least one ear depiction, so that the ear geometry is determined or co-determined on a basis of a comparison.

8. The method according to claim 1, which further comprises comparing the at least one ear depiction to previously stored other ear depictions, in which the ear geometry is known, so that the ear geometry is thus determined or co-determined.

9. The method according to claim 1, which further comprises displaying the at least one ear depiction and/or the ear geometry on a display device, and various dimensions or lengths of cables are placed as an optical image or as a three-dimensional graphic on a representation of the at least one ear depiction.

10. The method according to claim 1, which further comprises outputting the required length of the cable in relation to the ear geometry as a length specification on a display device.

11. The method according to claim 1, which further comprises outputting the required length of the cable in relation to the ear geometry as an indexed number on a display device.

12. The method according to claim 1, wherein the cable has an electrical conductor.

13. The method according to claim 1, wherein the cable has a receiver at one end.

14. The method according to claim 1, wherein the cable is formed as a tube with a cavity formed therein.
